(19) United States
(12) Patent Application Publication
(10) Pub. No.: US 2007/0243013 A1
(43) Pub. Date: Oct. 18, 2007

(54) Tool system for mechanical mounting assembly

(76) Inventor: William Gregory Hewitt, Taylors, SC (US)

Correspondence Address: THOMPSON COBURN, LLP, ONE US BANK PLAZA, SUITE 3500, ST LOUIS, MO, 63101, US

(21) Appl. No.: 11/403,649

(22) Filed: Apr. 13, 2006

(51) Int. Cl. B25G 3/00

(52) U.S. Cl. 403/351

(57) ABSTRACT

A tool system is disclosed for mounting a nut or similar mechanical component in a mechanical mounting system. The tool system includes a spanner ring that has a series of protrusions that engage notches or recesses in a nut to be driven in the mounting system. A series of external notches form pockets around an outer periphery of the spanner ring to allow the spanner ring to be forcibly driven by a power tool. The spanner ring may be reversibly mounted on the driven nut to permit the notches to be engaged for both tightening and loosening the nut in the mounting system. A wrench-drive ring may be interfaced with the spanner ring to drive the rings and nut in rotation where sufficient axial space is available to receive rotating power tool, such as an impact wrench.

### BACKGROUND

The present invention relates generally to the field of mechanical shaft mounting systems and similar structures, and particularly to tool sets for mounting and dismounting elements, such as specially-designed nuts in such systems.

A wide variety of mechanical mounting and coupling systems have been designed and are presently in use. In the area of rotating equipment, for example, couplings and sleeve-type systems are known for mounting radially concentric elements. Such elements might include, for example, shafts, couplings on shafts, hubs, bearings about shafts and hubs, and so forth. In many such systems, an external element is mounted on an internal element, typically a rotating element being mounted on a driven shaft or hub. Sleeves and other mechanical components are used to tightly engage the elements on the shaft or hub in order to ensure that the two rotate together.

A recent development in this field is represented by a unique system that uses a variable-depth grooved nut supported on a sleeve or other mechanical component. The nut may be mounted on a conforming flange or groove in a sleeve by virtue of an eccentric opening in the nut immediately adjacent to a variable-depth groove. The nut includes a threaded inner section that engages a sleeve or other mechanical component and, as the nut is tightened by interaction of the grooves, the sleeve may be drawn into or expelled from engagement with other mechanical components. The arrangement has proven extremely efficient and useful in mounting bearings, couplings and other components to mechanical shafts. Such a system is described in U.S. Pat. No. 6,939,053, commonly assigned with the present invention.

One difficulty that arises in these and other types of mechanical mounting and coupling systems involves the need to tighten the system upon installation, and loosen the system for servicing and removal. In particular, a system using an annular nut or similar device, such as in the system described above, must rely upon careful access to the nut for tightening and untightening. In a system of the type described above, for example, spanner wrench notches or apertures may be provided in the nut that allow for insertion of a spanner wrench for tightening and loosening. However, sufficient space often does not exist for such tools, and their ability to forcefully tighten the system, and then loosen the system once very tight is extremely limited. Moreover, space constraints in many applications simply do not permit effective use of power tools, such as impact wrenches and the like. In certain applications, for example, a shaft may extend either so far that a wrench cannot be positioned axially beyond the end of the shaft, or the shaft may be so short that other components, such as pumps, gear reducers, and so forth, are positioned immediately adjacent to the end of the shaft. In either case power tools are of very little use, and hand tools are generally inadequate for providing the mechanical force needed to sufficiently tighten and loosen the systems.

There is a need, therefore, for an improved tool arrangement that permits tightening and loosening of mechanical mounting systems, particularly of the type described above. Moreover, there is a need for a system that can simply and forcefully rotate annular nuts in such systems and that is designed to allow for both tightening and loosening through the use of power tools either positioned radially about the nut or axially at the end of a shaft or hub.

### BRIEF DESCRIPTION

The present invention provides a tool set for manipulating mechanical mounting systems designed to such needs. The tool set may be used with a wide range of mechanical mounting systems. However, it is particularly well-suited to systems of the type described above, wherein an annular nut is mounted about a shaft of hub and provided with notches or recesses for a spanner wrench or similar tool. The system may be used for both mounting and dismounting the nut, and permits the nut to be very tightly engaged in the mounting system, and loosened, at will. The tool set interfaces with such nuts and then may be driven by power tools, such as air hammers and the like. The tool effectively protects the nut from damage by itself interfacing with the power tools, allowing the nut to be tightened and loosened without direct contact with tools or devices that might otherwise damage the nut. The tool set may be reversibly mounted to permit loosening of the system. A secondary tool can be interfaced with a first component of the set to allow for the use of other power tools, such as impact wrenches where sufficient space is available axially from the shaft or hub.

### DRAWINGS

These and other features, aspects, and advantages of the present invention will become better understood when the following detailed description is read with reference to the accompanying drawings in which like characters represent like parts throughout the drawings, wherein:

FIG. 1 is an exploded view of a tool system in accordance with aspects of the present invention designed to be interfaced with a nut of a mechanical mounting system, such as for mounting a bearing on a shaft;

FIG. 2 is a plan view of a first element of the tool set, in this example a spanner ring that can be interfaced with a nut of the type shown in FIG. 1 to tighten and loosen the nut;

FIG. 3 is a side view of the spanner ring of FIG. 2;

FIG. 4 is an elevational view of a wrench-drive ring designed to interface with the spanner ring of FIG. 2;

FIG. 5 is a side view of the wrench-drive ring of FIG. 4;

FIG. 6 is an elevational view of an exemplary nut of the type shown in FIG. 1 and adapted to interface with the tool system of the invention;

FIG. 7 is a side view of the nut of FIG. 6;

FIG. 8 is a partial sectional view of the mechanical mounting system of FIG. 1 shown with the spanner ring of the invention in place for tightening or loosening the nut of the system; and

FIG. 9 is a partial sectional view similar to that of FIG. 8, but illustrating the addition of the wrench-drive ring of FIG. 4 for tightening and loosening the arrangement when sufficient axial space exists for doing so.

### DETAILED DESCRIPTION

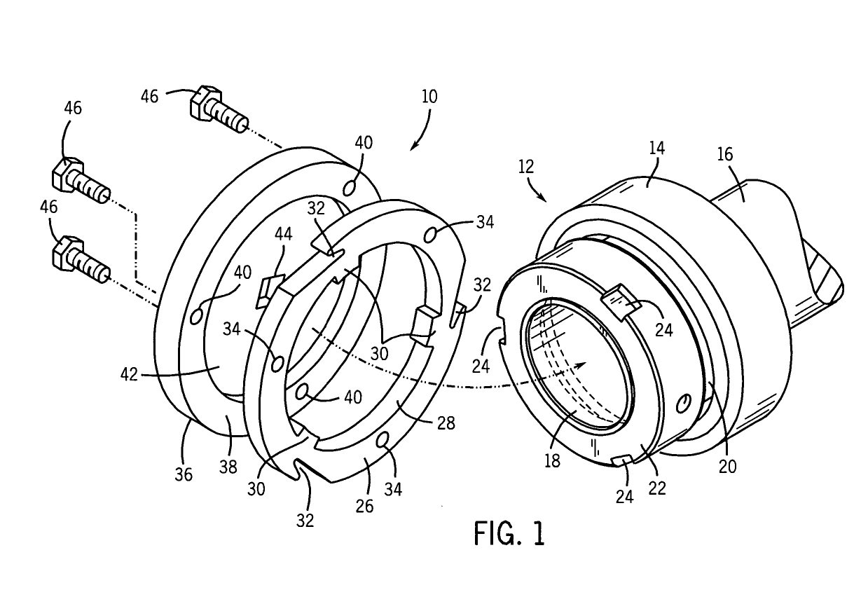

Turning now to the drawings, and referring first to FIG. 1, a tool system is illustrated and designated generally by reference numeral 10. The tool system may be used for tightening and loosening a mechanical mounting system designated by reference numeral 12. The mechanical mounting system may be used with a wide range of mechanical components, particularly for mounting such components coaxially with driving or driven shafts or hubs. By way of example only, in the illustration provided in the figures, the mechanical mounting system 12 is designed for mounting a bearing 14 on a shaft 16. Those skilled in the art will readily appreciate, however, that the tool set and its application described herein may be used, for example, for mounting rigid and flexible couplings to shafts, for mounting hubs about shafts, for mounting rotating components, such as gearing, and so forth about hubs and shafts, and so forth.

In the illustrated embodiment, the mechanical mounting system 12 includes a sleeve 18 that is received within a mechanical element 20, such as the inner ring of bearing 14. The sleeve, in the illustrated embodiment, fits tightly within the mechanical element, and is wedged between the mechanical element and the outer surface of shaft 16, as described in greater detail below. A nut 22 is secured to the sleeve 18 and serves to tightly draw the system together, rigidly securing the bearing and shaft components to one another during installation. As also described below, the nut can be manipulated to expel or withdraw the sleeve from the mechanical element, in this case bearing 14, for dismounting or disassembling the system, such as for servicing.

The nut 22 includes a series of spanner wrench notches 24 around its outer diameter. The spanner wrench notches 24 may be conveniently spaced and provided in number so as to permit a conventional spanner wrench to be used when initially tightening the nut in the mechanical mounting system. In the illustrated embodiment peripheral notches 24 are provided on the nut, and the nut may be axially engaged by the tool system as described below by sliding engagement with the notches. As will be appreciated by those skilled in the art, other axially slidable systems may be envisaged, such as nuts having holes or apertures in a face (in the axial direction) to receive pins or extensions from a tool as described below. Moreover, the number of notches in the nut may vary, with three such notches being provided in the illustrated embodiment.

The tool system 10 includes a spanner ring 26 designed to interface with nut 22. The spanner ring has an inner diameter 28 from which spanner extensions 30 protrude radially inwardly. The size and locations of the spanner extensions 30 match the size and locations of the spanner notches 24 of the nut 22. Moreover, the thickness of the spanner ring 26 is such that the spanner ring can be mounted either in the orientation illustrated in FIG. 1 or in a reverse or flipped orientation. That is, the spanner extensions 30 will enter into the spanner notches 24 in either orientation. As described more fully below, which permits the spanner ring to be forcefully driven to either tighten the nut or loosen the nut as desired.

Spanner ring 26 includes, around its outer periphery, a series of notches 32 which form pockets for interfacing with a driving tool (not shown). In use, and as described in greater detail below, a power tool, such as a chisel point on an air hammer can be lodged within the notches 32 to drive the spanner ring 26 in rotation, thereby driving the nut 22 to tighten and loosen the nut. Again, because the spanner ring 26 may be reversibly mounted on the nut 22, notches 32 will be oriented for creating a moment in either a right-hand or a left-hand direction for tightening and loosening the nut. It should also be noted that a series of threaded holes 34 are provided in spanner ring 26 for receiving fasteners, such as bolts, for securing the components of the tool system 10 to one another as described below.

In the illustrated embodiment, tool system 10 may further include a wrench-drive ring 36. Ring 36 is sized to correspond generally to the dimensions of the spanner ring 26, and has a thickened outer periphery 38 in which through-holes 40 are provided. The through-holes are positioned so as to align themselves with the threaded holes 34 of the spanner ring 26. A central wall 42 is provided on a rear side of the wrench-drive ring and will be described in greater detail below. Bolts 46 may be installed through the holes 40 in the wrench-drive ring and threaded into the threaded holes 34 of the spanner ring to secure the two rings to one another. As described in greater detail below, the addition of the wrench-drive ring 36 allows for the system to be driven by a power tool, such as an impact wrench (not shown), from an axial location.

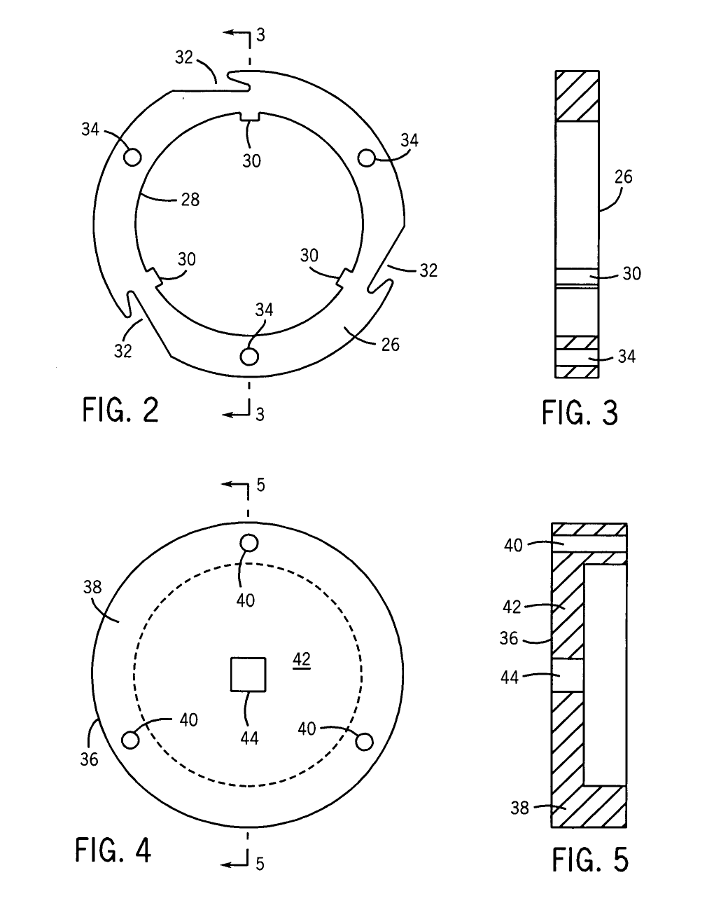

FIGS. 2-7 illustrate the foregoing components in somewhat greater detail. As shown in FIGS. 2 and 3, the spanner ring 26 has an inner diameter that generally corresponds to the outer diameter of nut 22 (see, FIG. 1). Protruding from the inner diameter 28 of the spanner ring is a series of spanner extensions 30 designed to interface with the spanner notches 24 of the nut. Around the outer periphery of the spanner ring are the notches 32. The ring itself may be made of any suitable material, such as hardened steel. In use, the ring will be subjected to substantial stresses, particularly during final installation of the system and at initial removal, and the material comprising the ring is selected to ensure durability during such use. In a present embodiment, the ring is fashioned by water jet cutting.

FIGS. 4 and 5 illustrate the wrench-drive ring 36 in accordance with a present embodiment. As discussed above, the ring is sized equivalently to the spanner ring 26. A series of through-holes 40 are provided around the periphery 38 of the ring, and an end of the ring is blinded by central web or wall 42. In the illustrated embodiment wrench-drive aperture 44 is provided in the center of the wall 42. The aperture 44 may be designed to receive any suitable type of power tool extension, such as a square shank of an impact wrench. Ring 36 may be made of a similar material to that of ring 26, and the two may be provided separately or together. That is, where desired, the tool system may include only ring 26, with ring 36 being provided as an option for applications where sufficient axial space is available for positioning a power tool used to drive the rings and nut via the drive aperture 44.

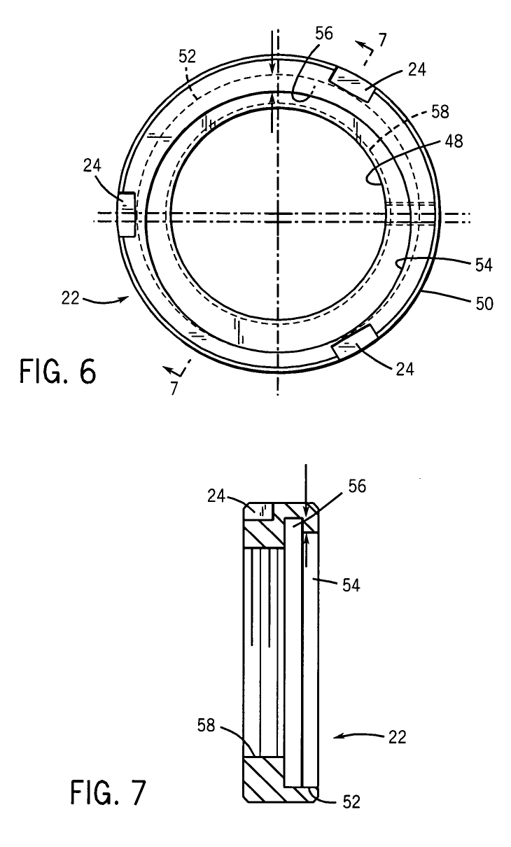

FIGS. 6 and 7 illustrate in somewhat greater detail certain features of the nut 22. While any number of nuts and rotating mechanical mounting elements may be manipulated and driven by the tool system described herein, the nut 22 is illustrated by way of example. The example is of particular interest insomuch as nuts of the type illustrated have proven to be extremely successful in providing simple and efficient mounting of mechanical components in rotating equipment. In the illustrated embodiment, nut 22 includes a series of spanner notches 24 around its outer periphery. An inner diameter 48 provides for passage of a shaft therethrough, where desired, and the outer periphery 50 may be partially or fully traversed by the spanner notches 24. A further inner diameter base 52 is cut or formed in the nut and is positioned adjacent to an eccentric wall 54 that forms an opening that is offset or eccentric from inner diameter 48. Together with base surface 52, the eccentric wall 54 forms a variable depth groove 56. The variable depth groove, and the dimension of the eccentric wall opening permits the nut to be mounted in the mechanical mounting system, but provides sufficient engagement for tightening and loosening the nut with its co-acting component as described below. Also illustrated in FIGS. 6 and 7, nut 22 includes a threaded section 58 designed to engage another component of the system, such as sleeve 18 illustrated in FIG. 1.

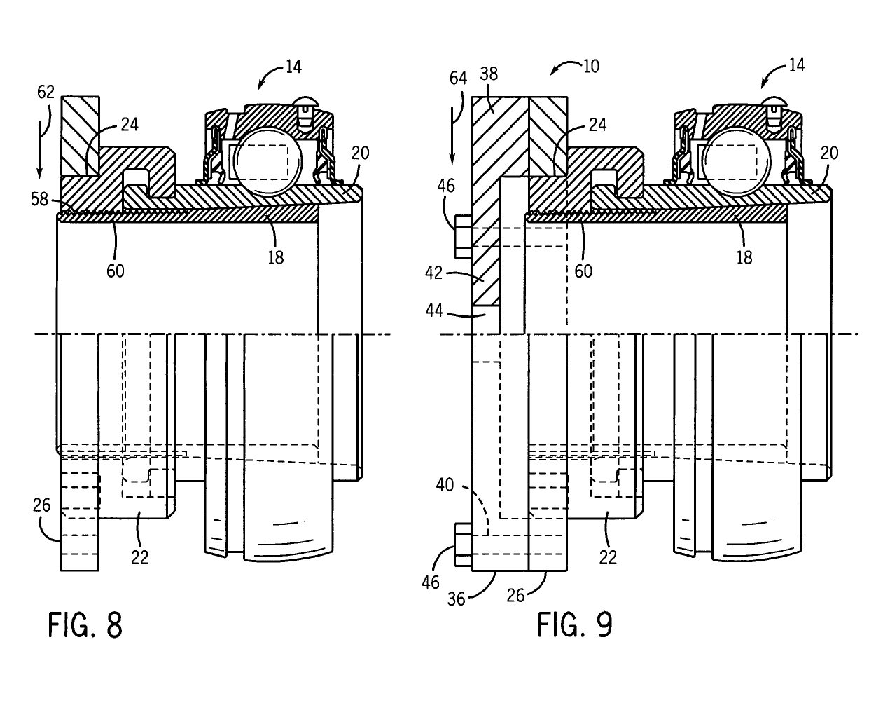

FIG. 8 illustrates the foregoing components mounted in an application. As shown in FIG. 8, for the illustrated arrangement, sleeve 18, with its tapered outer surface, fits within a tapered inner surface of the mechanical element 20, in this case an inner ring of bearing 14. The nut 22 is engaged with the mechanical element 20 by virtue of the variable depth groove 56 (see, FIGS. 6 and 7). The nut is also engaged with sleeve 18 which is provided with a threaded section 60 that engages a threaded section 58 of the nut 22.

In practice, these components may be mounted loosely by hand, and nut 22 initially tightened by hand and subsequently with a conventional spanner wrench. For final tightening of the nut, to secure the entire system in place, spanner ring 26 is placed over the nut so as to engage the spanner notches 24 therein. The ring is mounted so that the pockets formed by notches 32 (see, FIG. 1) permit a right-hand moment to be developed when forces are applied within the pockets, such as by a power tool. Rotation of the spanner ring and nut are thus effected, as indicated by arrow 62. As noted above, in a present embodiment, the spanner ring 26 is fully reversible and can be mounted in an opposite orientation on nut 22. Thus, in this reverse position the pockets presented by notches 32 (see, FIG. 1) allow for development of an oppositely oriented moment for removal of the nut and disassembly of the system.

The arrangement of FIG. 8 is particularly well-suited to situations in which very little space is provided at an end of the mounting system (i.e., to the left of the spanner ring 26 in FIG. 8), or where a shaft extends beyond the nut so as to make use of wrench-drive ring 36 impossible (due to the presence of the central wall in the ring). Where sufficient axial space is available and no such interfering component is present, the wrench-drive ring 36 may be added as illustrated in FIG. 9. As discussed above, this ring is conveniently bolted to the spanner ring and the pair of rings may then be disposed over the nut 22 so as to engage the spanner notches 24 therein. The entire tool system and the nut may then be driven by an axially positioned power tool (not shown) that engages the wrench-drive aperture 44 of the wrench-drive ring.

As noted above, the present embodiment illustrated in the figures is designed for engagement with external circumferential notches in the driven nut. However, as will be appreciated by those skilled in the art, other arrangements may be envisaged in which pins or protrusions extend from a face of the spanner ring that engage openings or apertures in a corresponding face of a nut to be driven in the mechanical driving system. For stabilization, the nut in such arrangements may be designed to fit partially or fully over the external diameter of the driven nut to hold the spanner ring in place.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A mechanical mounting system comprising, in combination,:
an threaded nut having a central opening, internal threads disposed on an internal surface of the central opening, an opening eccentric with the central opening, and a variable depth groove formed between the eccentric opening and the central opening, the threaded nut further including apertures for receiving a spanner wrench; and
a spanner ring having an inner periphery configured to fit around the outer periphery of the nut, extensions configured to engage the apertures of the nut, and notches disposed around an outer periphery of the ring for interfacing with a hand or power tool so as to create a rotational moment, whereby the spanner ring and nut may be tightened with respect to cooperating elements of a machine system.

2. The system of claim 1, wherein the spanner ring is configured to be mounted in reversible positions on the nut, whereby the notches of the spanner ring are oriented to produce, when receiving a force from a hand or power tool, a right-hand or a left-hand moment for tightening or loosening the nut with respect to the cooperating elements of the machine system.

3. The system of claim 1, wherein the notches form pockets suitable to receive a chisel or similar hand or power tool.

4. The system of claim 1, further comprising a wrench-drive ring configured to be coupled to the spanner ring, the wrench-drive ring including a central wall and an opening in the wall for receiving a drive shank of a power tool.

5. The system of claim 4, wherein the wrench-drive ring is configured to be coupled to the spanner ring by threaded fasteners that extend through the wrench-drive ring and are threaded into threaded apertures in the spanner ring.

6. The system of claim 1, wherein the spanner ring includes three notches evenly disposed around the outer periphery thereof.

7. The system of claim 1, wherein the apertures of the nut are formed in a radial outer periphery thereof, and the extensions of the spanner ring extend from the inner periphery thereof.

8. A mechanical mounting system comprising:
a spanner ring having an inner periphery configured to fit around the outer periphery of a nut, extensions configured to engage the apertures of the nut, and notches disposed around an outer periphery of the ring for interfacing with a hand or power tool so as to create a rotational moment, whereby the spanner ring and nut may be tightened with respect to cooperating elements of a machine system.

9. The system of claim 8, wherein the spanner ring is configured to be mounted in reversible positions on the nut, whereby the notches of the spanner ring are oriented to produce, when receiving a force from a hand or power tool, a right-hand or a left-hand moment for tightening or loosening the nut with respect to the cooperating elements of the machine system.

10. The system of claim 8, wherein the notches form pockets suitable to receive a chisel or similar hand or power tool.

11. The system of claim 8, further comprising a wrench-drive ring configured to be coupled to the spanner ring, the wrench-drive ring including a central wall and an opening in the wall for receiving a drive shank of a power tool.

12. The system of claim 11, wherein the wrench-drive ring is configured to be coupled to the spanner ring by threaded fasteners that extend through the wrench-drive ring and are threaded into threaded apertures in the spanner ring.

13. The system of claim 8, wherein the spanner ring includes three notches evenly disposed around the outer periphery thereof.

14. The system of claim 8, wherein the apertures of the nut are formed in a radial outer periphery thereof, and the extensions of the spanner ring extend from the inner periphery thereof.

15. A mechanical mounting system comprising:
a spanner ring having an inner periphery configured to fit around the outer periphery of a nut, extensions configured to engage the apertures of the nut, and notches disposed around an outer periphery of the ring for interfacing with a hand or power tool so as to create a rotational moment, whereby the spanner ring and nut may be tightened with respect to cooperating elements of a machine system; and
a wrench-drive ring configured to be coupled to the spanner ring, the wrench-drive ring including a central wall and an opening in the wall for receiving a drive shank of a power tool.

16. The system of claim 15, wherein the spanner ring is configured to be mounted in reversible positions on the nut, whereby the notches of the spanner ring are oriented to produce, when receiving a force from a hand or power tool, a right-hand or a left-hand moment for tightening or loosening the nut with respect to the cooperating elements of the machine system.

17. The system of claim 15, wherein the notches form pockets suitable to receive a chisel or similar hand or power tool.

18. The system of claim 15, further comprising a wrench-drive ring configured to be coupled to the spanner ring, the wrench-drive ring including a central wall and an opening in the wall for receiving a drive shank of a power tool.

19. The system of claim 18, wherein the wrench-drive ring is configured to be coupled to the spanner ring by threaded fasteners that extend through the wrench-drive ring and are threaded into threaded apertures in the spanner ring.

20. The system of claim 15, wherein the apertures of the nut are formed in a radial outer periphery thereof, and the extensions of the spanner ring extend from the inner periphery thereof.
